(19) United States
(12) Patent Application Publication
(10) Pub. No.: US 2019/0006078 A1
(43) Pub. Date: Jan. 3, 2019

(54) MAGNETIC ELEMENT

(71) Applicant: NTN CORPORATION, Osaka (JP)

(72) Inventors: Kayo SAKAI, Kuwana (JP); Eiichirou Shimazu, Kuwana (JP); Shougo Kanbe, Kuwana (JP); Shinji Miyazaki, Ama-gun (JP)

(73) Assignee: NTN CORPORATION, Osaka (JP)

(21) Appl. No.: 16/127,751

(22) Filed: Sep. 11, 2018

Related U.S. Application Data
(63) Continuation of application No. PCT/JP2017/009934, filed on Mar. 13, 2017.

(30) Foreign Application Priority Data
Mar. 15, 2016 (JP) 2016-050896

(51) Int. Cl. H01F 17/04; H01F 27/255; H01F 27/28

(52) U.S. Cl. CPC H01F 17/04; H01F 1/14733; H01F 27/2823; H01F 27/255

(57) ABSTRACT

Provided is a hybrid magnetic device obtained by combining a central core having a higher relative permeability than a peripheral core but is able to inhibit magnetic saturation of the peripheral core having a low relative permeability. The magnetic device (1) includes: a peripheral core (5) disposed around the outer periphery of a coil (3); a central core (6) having a higher relative permeability than the peripheral core (5); and connection core portions (6, 6) at the outsides of ends in an axial direction of the coil (3), each connecting the central and peripheral cores (4, 5). Each or one of the portions (6, 6) includes a flange (4a) integrated with the central core (4) and extending from the central core (4) toward the peripheral core (6). The portions (6, 6) include a connection element (5a) other than the flange (4a), integrated with the peripheral core (5).

### CROSS REFERENCE TO THE RELATED APPLICATION

This application is a continuation application, under 35 U.S.C. § 111(a), of international application No. PCT/JP2017/009934, filed Mar. 13, 2017, which claims Convention priority to Japanese patent application No. 2016-050896, filed Mar. 15, 2016, the entire disclosure of which is herein incorporated by reference as a part of this application.

### BACKGROUND OF THE INVENTION

### Field of the Invention

The present invention relates to a magnetic device used as a resin-molded magnetic core component or the like for an inductor, a transformer, an antenna (a bar antenna, etc.), a choke coil, a filter, a sensor, or the like in electrical or electronic equipment.

### Description of Related Art

In recent years, in the trend toward size reduction, frequency increase, and current increase of electrical or electronic equipment, a magnetic device called a core component or the like has also been required to follow the trend. However, the characteristics of a ferrite material, which is the mainstream at present, has almost reached the limit, and thus new materials are being searched for. The ferrite material has been replaced with new materials such as sendust and an amorphous foil band but such replacement is limited to some fields. An amorphous powder material having excellent magnetic characteristics has appeared, but has poor moldability as compared to conventional materials and thus has not been popularized.

### RELATED DOCUMENT

### Patent Document

[Patent Document 1] JP Patent No. 4763609

[Patent Document 2] JP Laid-open Patent Publication No. 2015-185673

### SUMMARY OF THE INVENTION

Meanwhile, Patent Document 1 discloses a method for producing a core component having predetermined magnetic characteristics by performing injection molding, wherein magnetic powder contained in a resin composition used in the injection molding is coated with an insulating material, a compression molded magnetic article or a compressed powder magnet molded article is insert-molded in the resin composition, and the compression molded magnetic article or the compressed powder magnet molded article contains a binding agent having a melting point lower than the injection molding temperature.

In addition, in a magnetic device including a core and a coil such as an inductor, a magnetic flux penetrating the interior of the core tends to pass through a path having good energy efficiency. Thus, a magnetic flux is more likely to be concentrated at a corner portion of a magnetic path than at a straight portion of the magnetic path. In particular, a central core having the coil wound thereon has a highest magnetic flux density, and thus a magnetic flux is more likely to be concentrated at a corner portion of a peripheral core near the central core than a corner portion of the peripheral core distant from the central core.

In a shape having a magnetic path cross-sectional area that changes at a flange portion as in a pot shape, magnetic fluxes flow as shown by arrows a1 in FIG. 22, and the magnetic flux density becomes high at and near a center close to a coil-wound portion.

Moreover, in a hybrid inductor in which a central core 104 has a higher relative permeability than a peripheral core 105 as shown in FIG. 21 (Patent Document 2), a magnetic flux is likely to be concentrated at peripheral core portions 104a near the ends of the central core 104, and the peripheral core portions 104a are also likely to become magnetically saturated since the saturated magnetic flux density thereof is low. When a core 102 becomes magnetically saturated, magnetic flux leakage occurs, so that the efficiency of the inductor decreases.

An object of the present invention is to provide a magnetic device that is a hybrid type obtained by combining a central core having a higher relative permeability than a peripheral core but is able to inhibit magnetic saturation of the peripheral core having a low relative permeability.

A magnetic device according to one aspect of the present invention includes: a peripheral core disposed around the outer periphery of a coil; a central core disposed on the inner periphery of the coil, the central core including a material having a higher relative permeability than the peripheral core; and first and second connection core portions positioned at the respective outsides of opposite ends in an axial direction of the coil, each of the first and second connection core portions connecting the central core and the peripheral core, wherein each of the both first and second connection core portions or either one of the first and second connection core portions includes a central core flange portion, the central core flange portion being integrated with the central core, the central core flange portion extending from the central core toward the peripheral core, and wherein the first and second connection core portions include a remaining portion other than the central core flange portion, the remaining portion including a connection element, the connection element being integrated with the peripheral core.

According to this configuration, since the magnetic device is a hybrid type including a peripheral core and a central core formed from a material having a higher relative permeability than the peripheral core, it is easy to adjust the relative permeability of the entire magnetic device to any value on the basis of a combination of the relative permeabilities of the peripheral core and the central core. Meanwhile, a hybrid type has a problem in which a peripheral core portion near each end of the central core is likely to become magnetically saturated. In this regard, according to the above configuration, the flange portion is provided to the central core such that a magnetic path corner portion near the central core having the coil wound thereon has a high relative permeability. That is, the connection core portion, which connects the central core and the peripheral core, includes a part of the central core as the flange portion, formed from a material having a high relative permeability. Accordingly, concentration of magnetic fluxes is alleviated, so that the peripheral core, formed from a material having a low relative permeability can be inhibited from becoming magnetically saturated at a corner portion of a magnetic path.

The central core flange portion may include a distal end having a stepped longitudinal cross-section, the distal end having outer and inner portions in the axial direction, the outer portion projecting more greatly toward the peripheral core than the inner portion. The connection may include a distal end having a longitudinal cross-section that meshes with the stepped longitudinal cross-section of the central core flange portion. In the case with this configuration, the central core and the peripheral core mesh with each other at the stepped distal ends, and thus can be positioned in the axial direction.

The connection core portion may have entirely or partially a double-layer structure, the double-layer structure including the central core flange portion and a peripheral core flange portion, the peripheral core flange portion being positioned inward of the central core flange portion in the axial direction, the peripheral core flange portion extending from the peripheral core toward the central core. Also in the case where the connection core portion has a double-layer structure in which the central core flange portion is positioned outward of the flange portion of the peripheral core in the axial direction, the central core and the peripheral core can be positioned in the axial direction.

In the case where the connection core portion has the step shape or the double-layer shape, the central core may have a gap in the axial direction thereinside. A gap can be used to attain desired magnetic characteristics. In the case where the central core and the peripheral core mesh with each other at the step-shaped portion, the bodies of the central core at both sides of the gap are positioned relative to the peripheral core in the axial direction. The bodies of the central core at both sides of the gap, which are positioned as described above, define the gap, and thus a spacer for ensuring the gap can be omitted.

Either one of the first and second connection core portions may have an area opposing an end surface in the axial direction of the central core across a gap, the entirety of the one of the connection core portions being formed of the connection element of the peripheral core. In the case with this configuration, the flange is provided at one end of the central core and the gap from the peripheral core is formed at the other end of the central core. Accordingly, even in the case where the central core is integrally molded without a gap being formed thereinside, a gap can be provided within the magnetic device, so that leakage of a magnetic flux to the coil can be inhibited.

At least one central core flange portion of the central core may extend to an inner circumferential surface of the peripheral core, the inner circumferential surface opposing the coil, and the central core may have a higher thermal conductivity than the peripheral core. When the flange portion of the central core having a high thermal conductivity extends to the inner circumferential surface of the peripheral core, a portion having a high thermal conductivity is broadened in the core of the magnetic device. Thus, the cooling performance of the magnetic device can be improved. Regarding the material used for the core, a material having a high relative permeability often has a high thermal conductivity.

The central core may be columnar, and the peripheral core may be cylindrical. The magnetic device may include a pot core. By providing the flange portion to the central core, magnetic saturation can be alleviated, and thus the thickness of the connection core portion can be reduced as compared to that in the case where no flange portion is provided.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a longitudinal cross-sectional view of a magnetic device according to a first embodiment of the present invention;

FIG. 2 is a plan view of the magnetic device in FIG. 1;

FIG. 3 is a longitudinal cross-sectional view of a magnetic device according to a second embodiment of the present invention;

FIG. 4 is a longitudinal cross-sectional view of a magnetic device according to a third embodiment of the present invention;

FIG. 5 is a longitudinal cross-sectional view of a magnetic device according to a fourth embodiment of the present invention;

FIG. 6 is a longitudinal cross-sectional view of a magnetic device according to a fifth embodiment of the present invention;

FIG. 7 is a longitudinal cross-sectional view of a magnetic device according to a sixth embodiment of the present invention;

FIG. 8 is a longitudinal cross-sectional view of a magnetic device according to a seventh embodiment of the present invention;

FIG. 9 is a longitudinal cross-sectional view of a magnetic device according to an eighth embodiment of the present invention;

FIG. 10 is a longitudinal cross-sectional view of a magnetic device according to a ninth embodiment of the present invention;

FIG. 11 is a longitudinal cross-sectional view of a magnetic device according to a tenth embodiment of the present invention;

FIG. 12 is a longitudinal cross-sectional view of a magnetic device according to an eleventh embodiment of the present invention;

FIG. 13 is a longitudinal cross-sectional view of a magnetic device according to a twelfth embodiment of the present invention;

FIG. 14 is a longitudinal cross-sectional view of a magnetic device according to a thirteenth embodiment of the present invention;

FIG. 15 is a longitudinal cross-sectional view of a magnetic device according to a fourteenth embodiment of the present invention;

FIG. 16 is a longitudinal cross-sectional view of a magnetic device according to a fifteenth embodiment of the present invention;

FIG. 17 is a longitudinal cross-sectional view of a magnetic device according to a sixteenth embodiment of the present invention;

FIG. 18 is a longitudinal cross-sectional view of a magnetic device according to a seventeenth embodiment of the present invention;

FIG. 19 is a longitudinal cross-sectional view of a magnetic device according to an eighteenth embodiment of the present invention;

FIG. 20 is a perspective view of a core of a magnetic device according to a nineteenth embodiment of the present invention;

FIG. 21 is a cross-sectional view of a conventional magnetic device; and

FIG. 22 illustrates magnetic flux flow in a conventional magnetic device.

### DESCRIPTION OF EMBODIMENTS

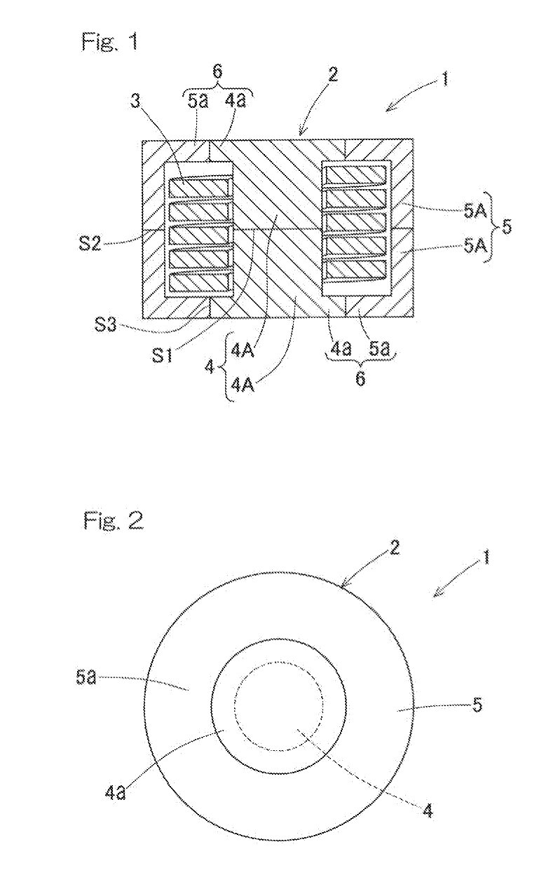

A first embodiment of the present invention will be described with reference to FIG. 1 and FIG. 2. A magnetic device 1 includes a core 2 and a coil 3. The core 2 includes: a peripheral core 5, located on the outer periphery of the coil 3; and a central core 4, which is located on the inner periphery of the coil 3. The central core 4 is formed from a material having a higher relative permeability than the peripheral core 5. On the outsides of opposite ends in an axial direction of the coil 3, connection core portions 6, 6 are formed, respectively. At the connection core portions 6, 6, the central core 4 and the peripheral core 5 are joined. Each connection core portion 6 includes a flange portion 4a of the central core 4 and a flange-shaped connection element 5a, which is a part of the peripheral core 5. The flange portion 4a extends from a columnar portion of the central core 4 in the radial direction along the coil 3. The connection element 5a is located at the radially outward of the flange portion 4a. The material of the central core 4 also has a higher thermal conductivity than the peripheral core 5.

The magnetic device 1 includes a pot core. The central core 4 has a flanged columnar shape while the peripheral core 5 has a flanged cylindrical shape. The flange portion 4a and the connection element 5a each have a circular shape as viewed in the axial direction. The central core 4 includes two central core bodies 4A, 4A, which are separate but united into the central core. The peripheral core 5 includes two peripheral core bodies 5A, 5A, which are separate but united into the peripheral core. The central core bodies 4A, 4A as well as the peripheral core bodies 5A, 5A are aligned in the axial direction. The separate bodies 4A, 4A, 5A, 5A enables work for housing the coil 3 therein. The central core bodies 4A, 4A are in contact with each other, the peripheral core bodies 5A, 5A are in contact with each other, and contact surfaces S1 and S2 thereof are bonded by an adhesive. The flange portions 4a and the connection elements 5a of the respective connection core portions 6 are in contact with each other, and contact surfaces S3 thereof are joined by an adhesive.

The coil 3 is formed by winding a rectangular conductor wire in a single layer in the shown example, and a bobbin is not used. Alternatively, the coil 3 may be formed of a round conductor wire wound on a bobbin in multiple layers. A bobbin may be used for a rectangular wire coil, or may be used for a round wire coil, depending on required insulation characteristics or the like. When the coil is formed of a self-bonding wire, a bobbin may not be used.

An example of the material of the core 2 will be described. The central core 4 is formed, for example, as a compression molded magnetic article or the like using a ferrite material obtained by a compression molding method. The ferrite material has a high relative permeability, which enables high inductance. The peripheral core 5 is formed, for example, as an injection molded magnetic article or the like using an injection molding magnetic material containing an amorphous material. The magnetic device using the injection molding magnetic material containing the amorphous material has excellent frequency characteristics and superimposed current characteristics but has a low permeability.

Examples of raw materials of the compression molded magnetic article for the central core 4 include magnetic materials including: pure iron-based soft magnetic materials such as iron powder and iron nitride powder; ferrous alloy-based soft magnetic materials such as Fe—Si—Al alloy (sendust) powder, super sendust powder, Ni—Fe alloy (permalloy) powder, Co—Fe alloy powder, and Fe-Si-B-based alloy powder; ferrite-based magnetic materials; amorphous magnetic materials; and microcrystalline materials.

The injection molded magnetic article for the peripheral core 5 is obtained by blending a binding resin into material powder for the compression molded magnetic article and performing injection-molding on the mixture. The magnetic powder is preferably amorphous metal powder; since injection molding is easily performed, the shape after the injection molding is easily maintained, and a composite magnetic body formed therefrom has good magnetic characteristics, for example. As the amorphous metal powder, the above-described iron-based alloy powder, cobalt-based alloy powder, nickel-based alloy powder, and mixed alloy amorphous powder thereof can be used. An insulating coating is formed on these amorphous metal powder surfaces. As the binding resin, a thermoplastic resin which allows for injection molding can be used. As the thermoplastic resin, polyethylene or other various resins can be used.

Since the magnetic device 1 having this configuration is a hybrid type including the peripheral core 5 and the central core 4 formed from a material having a higher relative permeability than the peripheral core 5, it is easy to adjust the relative permeability of the entire magnetic device 1 to any value on the basis of a combination of the relative permeabilities of the peripheral core 5 and the central core 4. However, a hybrid type generally has a problem in which a peripheral core portion near each end of the central core 4 is likely to become magnetically saturated.

In this embodiment, the flange portion 4a is provided to the central core 4 such that a magnetic path corner portion near the portion of the central core 4 having the coil 3 wound thereon has a high relative permeability. That is, the connection core portion 6, which connects the central core 4 and the peripheral core 5, includes a part of the central core 4 as the flange portion 4a, formed from a material having a high relative permeability. Accordingly, concentration of magnetic fluxes is alleviated, so that the peripheral core 5, formed from a material having a low relative permeability can be inhibited from becoming magnetically saturated.

In addition, the magnetic device of this embodiment has the pot-shaped central core 4, to which the flange portion 4a is added, whereby magnetic saturation can be alleviated. Thus the thickness of the connection core portion 6 can be reduced as compared to that in the case where no flange portion 4a is provided.

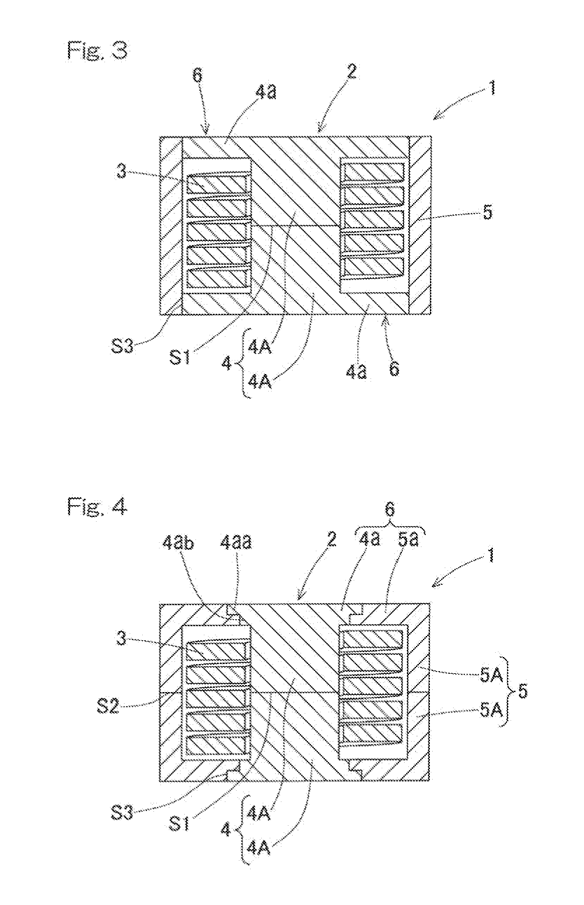

FIG. 3 to FIG. 20 illustrate second to nineteenth embodiments of the present invention, respectively. In these embodiments as well, the above effect of alleviating magnetic saturation is achieved. These embodiments are the same as the first embodiment described with reference to FIG. 1 and FIG. 2, except for matters described in particular.

In a magnetic device 1 according to the second embodiment shown in FIG. 3, each flange portion 4a of the central core 4 extends to the inner circumferential surface of the peripheral core 5 and forms the entirety of the corresponding connection core portion 6. The central core 4 includes two central core bodies 4A, 4A, but the peripheral core 5 does not have a division structure and the entirety thereof is integrally formed.

In the case of this configuration as well, a material having a high relative permeability is disposed at the magnetic path corner portions, that is, each of the magnetic path corner portions is formed as the corresponding flange portion 4a which is a part of the central core 4, and thus magnetic saturation can be avoided. In addition, in the case of this configuration, the outer diameter of the flange portions 4a of the central core 4 are equal to or larger than the inner diameter of the peripheral core 5, so that the peripheral core 5 is integrally formed without causing a problem for assembling the coil 3 and thus the number of components is reduced.

In a magnetic device 1 according to the third embodiment shown in FIG. 4, the longitudinal cross-sectional shapes of the distal ends, that is, the outer peripheral ends, of the flange portions 4a of the central core 4 are step shapes. Specifically, each of the flange portions 4a has a step shape in which an outer portion 4aa thereof in the axial direction projects more greatly than an inner portion 4ab thereof. The distal ends, that is, the inner peripheral ends, of the respective connection elements 5a of the peripheral core 5 have longitudinal cross-sectional shapes which mesh with the respective step shapes of the flange portions 4a of the central core 4.

In the case of this configuration as well, a material having a high relative permeability is disposed at the corner portion, and thus magnetic saturation can be avoided. In addition, in the case of this configuration, the central core 4 and the peripheral core 5 mesh with each other at the step-shaped portions at the distal ends of the respective flange portions 4a, and thus can be positioned in the axial direction with high accuracy.

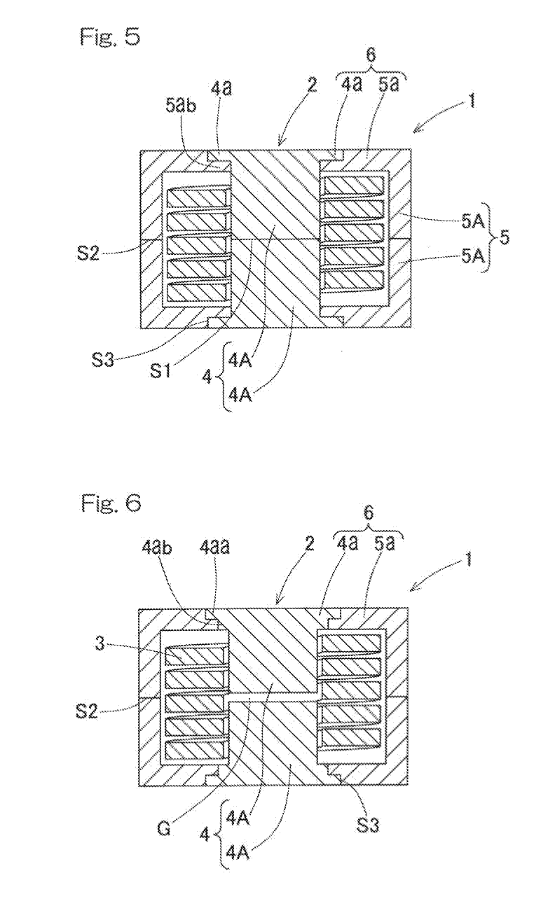

In a magnetic device 1 according to the fourth embodiment shown in FIG. 5, the thicknesses of the flange portions 4a extending from the central core 4 is small, and the distal ends, that is, the inner peripheral ends, of the respective connection elements 5a of the peripheral core 5 have step shapes in which an inner portions thereof in the axial direction project by the same dimension as the radial dimension of the flange portions 4a. Thus, each of the radially inner portions of the connection core portion 6 has a double-layer structure including the flange portion 4a and a flange portion 5ab which is located inward of the flange portion 4a in the axial direction and extends from the peripheral core.

In the case of this configuration as well, a material having a high relative permeability is disposed at the corner portions, and thus magnetic saturation can be avoided. In addition, in the case of this configuration, each of the connection core portions 6 has a double-layer structure including the flange portion 4a of the central core 4 and the flange portion 5ab of the peripheral core 5, and the central core 4 and the peripheral core 5 mesh with each other at the step-shaped portions due to the double-layer structure, and thus can be positioned in the axial direction with high accuracy.

A magnetic device 1 according to the fifth embodiment shown in FIG. 6 is configured such that, in the magnetic device 1 according to the embodiment in FIG. 4, the central core 4 has a gap G at a halfway position in the axial direction. The gap G is formed between the two central core bodies 4A, 4A of the central core 4.

Since the gap G is provided within the magnetic device 1, leakage of a magnetic flux to the outside is inhibited. In addition, the magnetic characteristics of the magnetic device 1 can be adjusted by the gap G. In the case where the gap G is provided within the magnetic device 1, although a spacer (not shown) is disposed at a location where the gap G is to be formed in the conventional art, the two central core bodies 4A, 4A are positioned relative to each other by the step shapes as described in the example of FIG. 4, in this embodiment. Thus, the gap G can be formed without providing a spacer.

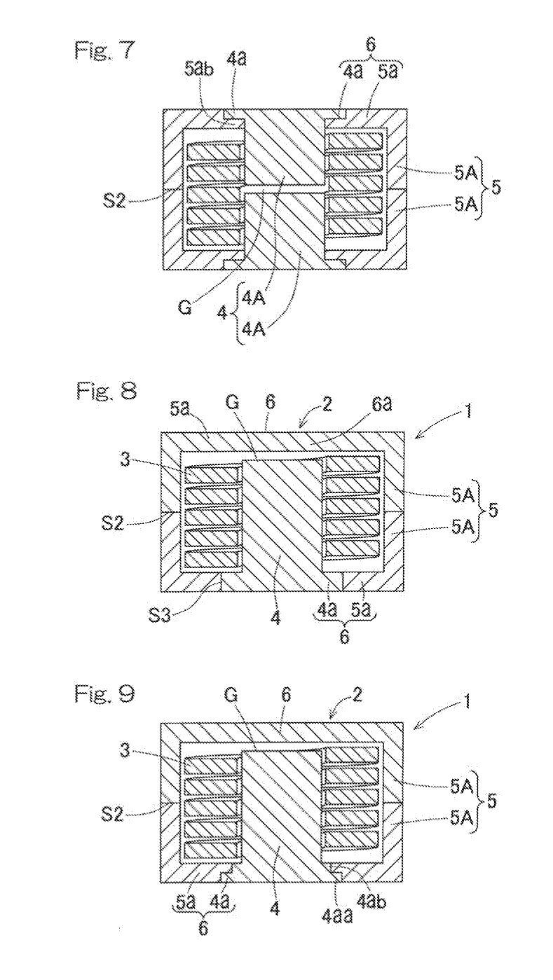

A magnetic device 1 according to the sixth embodiment shown in FIG. 7 is configured such that, in the magnetic device 1 according to the embodiment in FIG. 5, the central core 4 has a gap G at a halfway position in the axial direction. The gap G is formed between the two central core bodies 4A, 4A of the central core 4.

In the case of this embodiment, as described in the example of FIG. 5, the two central core bodies 4A, 4A are positioned relative to each other by the step shapes formed by the respective connection core portions 6, each having a double-layer structure. Thus, similar to the example of FIG. 6, the gap G can be formed without providing a spacer.

A magnetic device 1 according to the seventh embodiment shown in FIG. 8 is configured such that, in the magnetic device 1 according to the embodiment in FIG. 1, the connection core portion 6 at a first end (the upper one on FIG. 8) of the connection core portions 6, 6 at both ends has a shape having a portion 6a opposing the end surface of the central core 4 across the gap G. The connection core portion 6 is entirely formed of a connection element 5a of the peripheral core 5. The entire central core 4 is integrally formed.

This example is a magnetic device 1 in which a spacer for the gap G is omitted in the case where the central core 4 is integrally formed. At one end of the central core 4 (at a second end opposite to the first end), the flange portion 4a is provided, and concentration of magnetic fluxes at the corner portion is alleviated. By setting the flange portion 4a as a mounting side, the installation area of the central core 4 having a good thermal conductivity is increased, and cooling performance is improved as compared to that with a central core having a straight shape (not shown). By providing the gap G from the peripheral core 5 at the other end of the central core 4 (at the first end), the gap G can be provided within the magnetic device 1, which is used as an inductor or the like, and thus leakage of a magnetic flux to the coil 3 can be inhibited. Concentration of magnetic fluxes does not occur around the gap G, and thus the corner portion near the gap G does not become magnetically saturated.

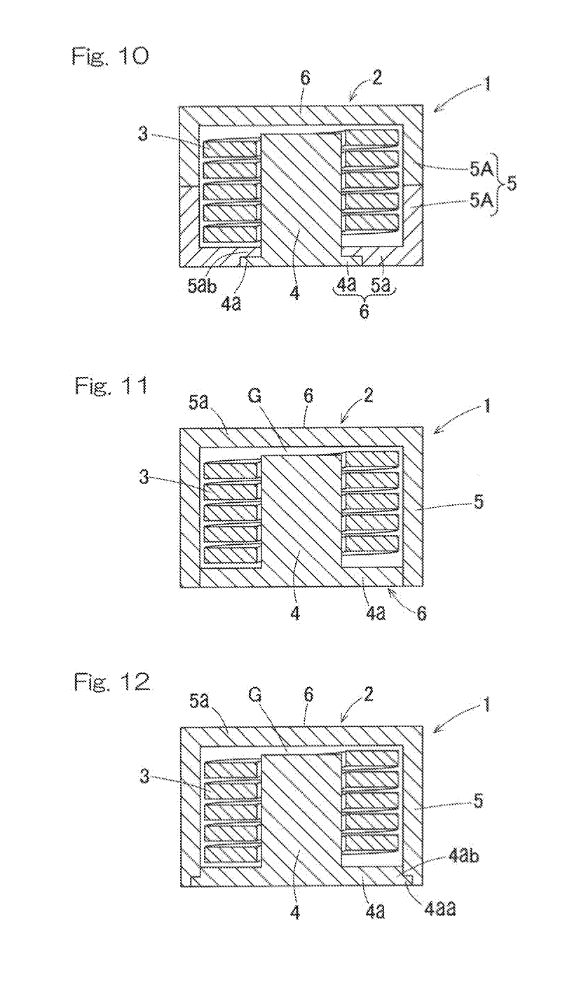

In the magnetic device 1 according to the embodiment in FIG. 8, the connection core portion 6 at the side at which the flange portion 4a is provided to the central core 4 (at the second end) may be configured such that the distal end of the flange portion 4a has a step shape as described in the example of FIG. 4 (a magnetic device 1 according to the eighth embodiment shown in FIG. 9), or may have a double-layer structure including the flange portion 4a of the central core 4 and a flange portion 5ab of the peripheral core 5 as described in the example of FIG. 5 (a magnetic device 1 according to the ninth embodiment shown in FIG. 10).

A magnetic device 1 according to the tenth embodiment shown in FIG. 11 is an example in which, in the magnetic device 1 according to the embodiment shown in FIG. 8, the distal end of the flange portion 4a of the central core 4 reaches the inner circumferential surface of the peripheral core 5. That is, the radial positions of the outer circumferential surface of the flange portion 4a and the inner circumferential surface of the peripheral core 5 coincide with each other. The entire peripheral core 5 is integrally formed.

A magnetic device 1 according to the eleventh embodiment shown in FIG. 12 is an example in which, in the magnetic device 1 according to the embodiment shown in FIG. 9, the inner portion 4ab of the flange portion 4a of the central core 4 extends to the inner circumferential side surface of the peripheral core 5. That is, the radial positions of the outer circumferential surface of the inner portion 4ab of the flange portion 4a and the inner circumferential surface of the peripheral core 5 coincide with each other.

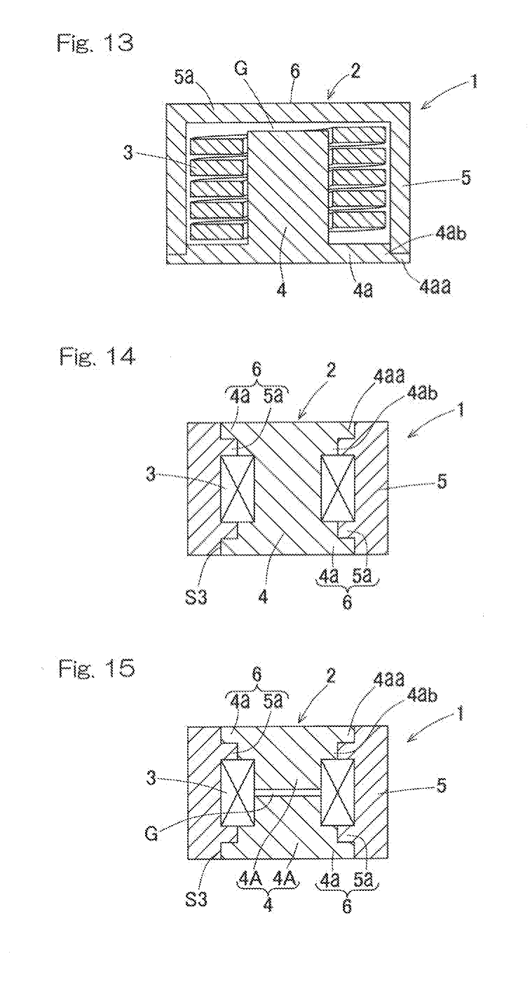

A magnetic device 1 according to the twelfth embodiment shown in FIG. 13 is configured such that, in the magnetic device 1 according to the embodiment shown in FIG. 12, the outer portion 4aa of the flange portion 4a of the central core 4 extends to the outer circumferential surface of the peripheral core 5, so that the flange portion 4a covers the end surface in the axial direction of the peripheral core 5.

In each of these examples of FIG. 11 to FIG. 13, since the flange portion 4a of the central core 4 is enlarged to the inner periphery of the cylindrical portion of the peripheral core 5, the peripheral core 5 can be formed as an integral component without causing a problem for assembling the coil 3, and thus the number of components can be reduced. In addition, as compared to the examples of FIG. 8 to FIG. 10, the area of the flange portion 4a of the central core 4 having a high thermal conductivity is larger, and thus cooling performance is improved.

In each of magnetic devices 1 according to the thirteenth to eighteenth embodiments shown in FIG. 14 to FIG. 19, respectively, the coil 3 is shown in a simplified manner, but, similar to the examples of FIG. 1 to FIG. 13, the coil 3 is formed of a rectangular conductor wire wound in a single layer. In these examples as well, the coil 3 may be formed of a round wire wound in multiple layers.

The magnetic device 1 according to the thirteenth embodiment shown in FIG. 14 is configured such that, in the magnetic device 1 according to the embodiment in FIG. 4, the flange portions 4a of the central core 4 extends to the inner circumferential surface of the tubular peripheral core 5. That is, the radial positions of the outer circumferential surface of the flange portions 4a and the inner circumferential surface of the peripheral core 5 coincide with each other.

The magnetic device 1 according to the fourteenth embodiment shown in FIG. 15 is configured such that, in the magnetic device 1 according to the embodiment in FIG. 14, a gap G is provided halfway in the axial direction in the central core 4. The gap G is formed between the two central core bodies 4A, 4A of the central core 4.

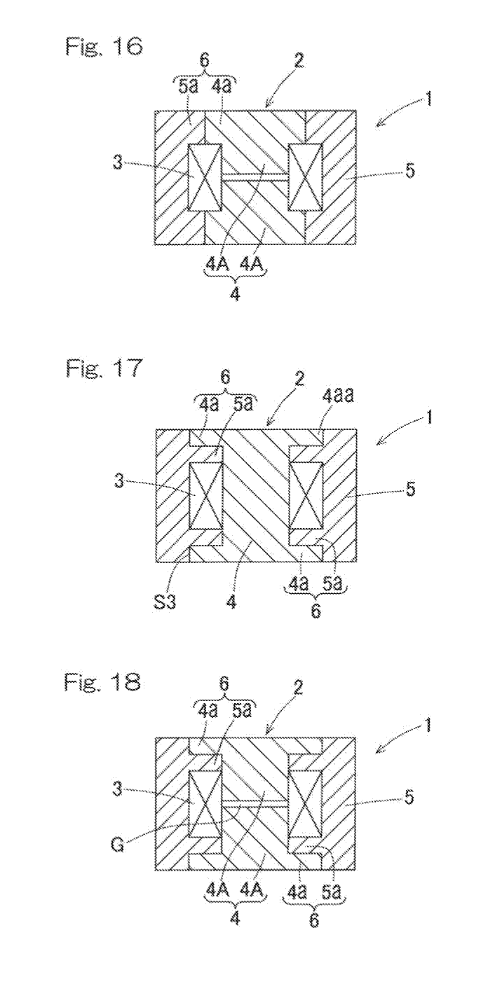

The example of the magnetic device 1 according to the fifteenth embodiment shown in FIG. 16 is configured such that, in the magnetic device 1 according to the embodiment in FIG. 1, a gap G is provided halfway in the axial direction in the central core 4. The gap G is formed between the two central core bodies 4A, 4A of the central core 4. However, the dimensional relationship between the respective portions is different from that in the embodiment in FIG. 1.

The magnetic device 1 according to the sixteenth embodiment shown in FIG. 17 is configured such that, in the magnetic device 1 having a double-layer structure according to the embodiment in FIG. 5, the outer portions 4aa of the flange portions 4a of the central core 4 extend to the inner circumferential surface of the cylindrical peripheral core 5. That is, the radial positions of the outer circumferential surfaces of the flange portions 4a and the inner circumferential surface of the peripheral core 5 coincide with each other.

The magnetic device 1 according to the seventeenth embodiment shown in FIG. 18 is configured such that, in the magnetic device 1 according to the embodiment in FIG. 17, a gap G is provided halfway in the axial direction in the central core 4. The gap G is formed between the two central core bodies 4A, 4A of the central core 4.

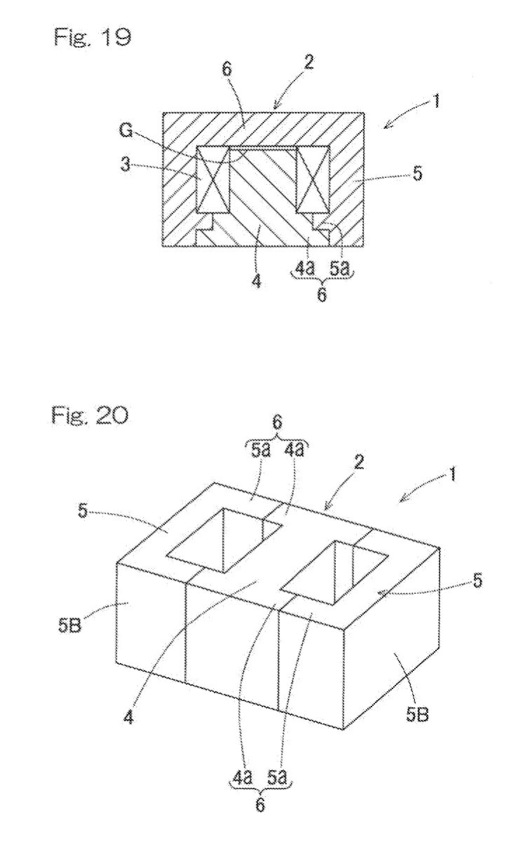

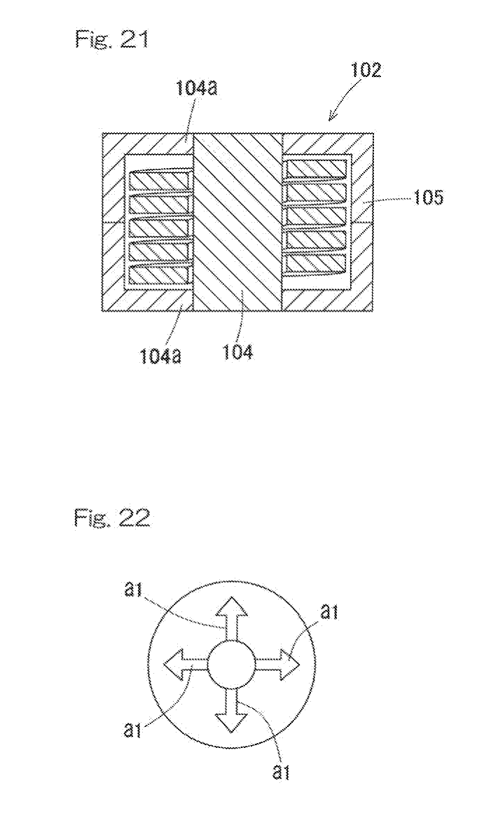

The eighteenth embodiment shown in FIG. 19 is configured such that, in the magnetic device 1 according to the embodiment in FIG. 10, the flange portion 4a of the central core 4 extends to the inner circumferential surface of the cylindrical peripheral core 5. That is, the radial positions of the outer circumferential surface of the flange portion 4a and the inner circumferential surface of the peripheral core 5 coincide with each other.

The magnetic device 1 according to the nineteenth embodiment shown in FIG. 20 is configured as a magnetic device 1 called an EE type as a whole in which, in the magnetic device 1 according to the embodiment in FIG. 1, the central core 4 has a rod shape with a quadrangular cross-section and the peripheral core 5 includes two rod-shaped peripheral core bodies 5B, 5B located at both sides of the central core 4.

In the case of being configured as an EE type as described above as well, magnetic saturation occurring in the magnetic material having a low relative permeability can be inhibited by providing the flange portions 4a to the central core 4.

In each of the embodiments in FIG. 3 to FIG. 19 as well, the magnetic device 1 may be configured as an EE type similar to the example of FIG. 20, and the respective advantageous effects described in the respective embodiments are achieved.

The magnetic device 1 of each embodiment described above is used, for example, as a resin-molded magnetic core component or the like for an inductor, a transformer, an antenna (a bar antenna, etc.), a choke coil, a filter, a sensor, or the like in electrical or electronic equipment.

Although the modes for carrying out the present invention have been described on the basis of the embodiments, the embodiments disclosed herein are illustrative in all aspects and not restrictive. The scope of the present invention is indicated by the claims, rather than by the above description, and is intended to include any modifications within the scope and meaning equivalent to the claims.

### REFERENCE NUMERALS

1 . . . magnetic device

3 . . . coil

4 . . . central core

4a . . . central core flange portion

5 . . . peripheral core

5a . . . connection element

6 . . . connection core portion

What is claimed is:

1. A magnetic device comprising:
a peripheral core disposed around the outer periphery of a coil;
a central core disposed on the inner periphery of the coil, the central core including a material having a higher relative permeability than the peripheral core; and
first and second connection core portions positioned at the respective outsides of opposite ends in an axial direction of the coil, each of the first and second connection core portions connecting the central core and the peripheral core, wherein
each of the both first and second connection core portions or either one of the first and second connection core portions includes a central core flange portion, the central core flange portion being integrated with the central core, the central core flange portion extending from the central core toward the peripheral core, and wherein
the first and second connection core portions include a remaining portion other than the central core flange portion, the remaining portion including a connection element, the connection element being integrated with the peripheral core.

2. The magnetic device as claimed in claim 1, wherein the central core flange portion includes a distal end having a stepped longitudinal cross-section, the distal end having outer and inner portions in the axial direction, the outer portion projecting more greatly toward the peripheral core than the inner portion, and wherein the connection element includes a distal end having a longitudinal cross-section that meshes with the stepped longitudinal cross-section of the central core flange portion.

3. The magnetic device as claimed in claim 1, wherein the connection core portion has entirely or partially a double-layer structure, the double-layer structure including the central core flange portion and a peripheral core flange portion, the peripheral core flange portion being positioned inward of the central core flange portion in the axial direction, the peripheral core flange portion extending from the peripheral core toward the central core.

4. The magnetic device as claimed in claim 2, wherein the central core has a gap in the axial direction thereinside.

5. The magnetic device as claimed in claim 2, wherein either one of the first and second connection core portions has an area opposing an end surface in the axial direction of the central core across a gap, the entirety of the one of the connection core portions being formed of the connection element of the peripheral core.

6. The magnetic device as claimed in claim 1, wherein at least one central core flange portion of the central core extends to an inner circumferential surface of the peripheral core, the inner circumferential surface opposing the coil, and wherein the central core has a higher thermal conductivity than the peripheral core.

7. The magnetic device as claimed in claim 1, wherein the central core is columnar, and wherein the peripheral core is cylindrical.
